(19) United States
(12) Patent Application Publication
(10) Pub. No.: US 2005/0006414 A1
(43) Pub. Date: Jan. 13, 2005

(54) Extruding implement structure

(76) Inventor: Yu-Chun Tseng, Tainan City (TW)

Correspondence Address: BACON & THOMAS, PLLC, 625 SLATERS LANE, FOURTH FLOOR, ALEXANDRIA, VA, 22314, US

(21) Appl. No.: 10/606,741

(22) Filed: Jun. 27, 2003

(51) Int. Cl. B67D 5/42

(52) U.S. Cl. 222/391

(57) ABSTRACT

The extruding implement structure of the present invention comprises a handle pivotally connected to a rear base and disposed on one side of the base, and is substantially parallel to the base or in an aslant position, using a first resisting arm to press against a pushing member of a first exerting arm pivotally coupled to a rear base, and the pushing member uses a second resisting arm on the other end of the pivotal point to press against the first latch plate and drive the push rod to push and press against the silicon gel can for the gel injection. A latch member is disposed between the outside of the rear base and the second latch plate such that the silicon gel will not keep on squeezing the silicon gel after the operation is stopped.

### BACKGROUND OF THE INVENTION

1. Field of the Invention

This invention relates to an extruding implement structure, more particularly to an extruding implement structure used for squeezing the contents contained in a can featuring its easy application and easy control, and saving the volume of packaging materials.

2. Description of the Related Art

In general, a silicon gel which is common in construction, decoration, or DIY construction in family, is generally used for waterproof sealing, and an extruding implement is generally used for squeezing the silicon gel. Please refer to FIG. 1 for a general extruding implement structure, which comprises: a base 1; a front blocking base 12 disposed at the front end; a rear base 13 disposed at the rear end; a silicon gel can 2 accommodated in the base 1 such that a conical nozzle 21 of the silicon can 2 being protruded to the front of the front blocking base 12; a push rod 3 passing through the rear base 13, having a press disc 31 disposed at its front end and pressing against a rear cover 22 and being displaceable in the silicon gel can 2; a first elastic member 32 and a fat latch plate 33 being pivotally coupled to a hole 14 disposed at the rear base 13 of the push rod 3; a second elastic member 34 and a second latch plate 35 being pivotally coupled to the rear base 13 of the push rod 3, such that one end of the second latch plate 35 is latched into the latch base 15; the rear base 13 has a blocking base 161; a handle 4 including a fixed handle 41 and a movable handle 42, wherein the movable handle 42 has a pivotal point 421 on the rear base 13 to define an exerting arm 422 and a press rod 423 extended into the hollow hole 14 for pressing a resisting arm 424 of the first latch plate 33. If a gel injection is needed, the movable handle 42 is held as shown in FIG. 2; the press rod 423 will press against the first latch plate 33 to an aslant position; and the axial hole 331 latches the press rod 3 and drives it forward. When the movable handle 42 is released, since the second latch plate 35 is still pressed by the second elastic member 34 to tilt the latch push rod 3, therefore only the first latch plate 33 shifts backward due to the restoration of the first elastic member 32, but the push rod remains still. If we want to shift the push rod backward, we need to press the second latch plate 35 against the blocking body 6, so that the axial hole 351 of the second latch plate 35 will release the aslant latch rod 3 by the pressing of the second elastic member 34, and then the push rod can be pulled backward.

The handle of such extruding implement is vertical to the silicon gel can, not only wasting the space for the overall packaging volume, but since the silicon gel can is very heavy, the base 1 is made of metal, and the handle is disposed on one side of the base 1, therefore the moment of the loading is quite large. The operator's hand will turn red and swollen by pressing the silicon gel while supporting the aforementioned moment of the force. The squeezing movement of pressing the handle 4 also adds the force of moment to the base. Therefore, the operator usually needs to hold the base 1 with one hand, and grab the handle 4 with the other hand for the operation. If the operator stands on a stairway or unstable piled objects for the construction, such operation becomes very dangerous. Further, since silicon gel is a semi-solidified liquid, the silicon gel in the silicon gel can 2 will continue to be squeezed out under the inertia action even after the movable handle 42 is released and the second latch plate 35 has not driven the push rod 3 forward. It will cause inconvenience and waste.

### SUMMARY OF THE INVENTION

The objective of this invention is to provide an extruding implement, comprising a base; a front blocking base disposed at the front end; a rear base disposed at the rear end; a silicon gel can accommodated in the base between the front blocking base and the rear base; a push rod passing through the rear base, and one end of the push rod extending deep into the base and pressing the movable rear cover in the silicon gel can. The push rod inside the rear base is pivotally coupled to a first elastic member and a first latch plate; the push rod outside the rear base is pivotally coupled to a second elastic member and a second latch plate. A handle is pivotally coupled to the rear base, and disposed on one side of the rear base, substantially parallel to the base and the push rod or in an aslant position. If a user wants to push the push rod forward to press the pressing disc deep into the silicon gel can and push the rear cover for the gel injection, the user just holds the handle and pushes the handle towards the base.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

Other features and advantages of the present invention will become apparent in the following detailed description of the preferred embodiments with reference to the accompanying drawings, in which:

FIG. 1 is an illustrative diagram of the structure of a prior-art extruding implement.

FIG. 2 is an illustrative diagram of the operation of a prior-art extruding implement.

FIG. 3 is an illustrative diagram of the structure of a preferred embodiment of the present invention.

FIG. 4 is an illustrative diagram of the operation of a preferred embodiment of the present invention.

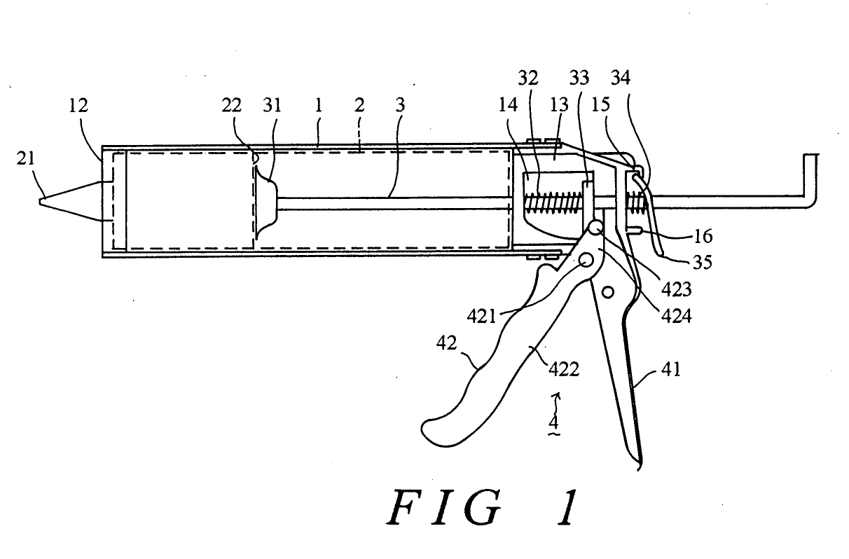

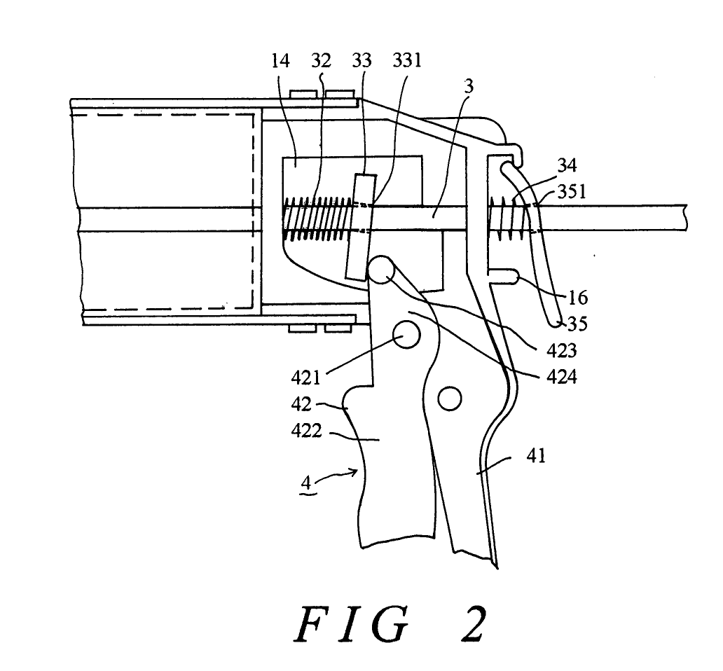

### DETAILED DESCRIPTION OF THE PREFERRED EMBODIMENTS

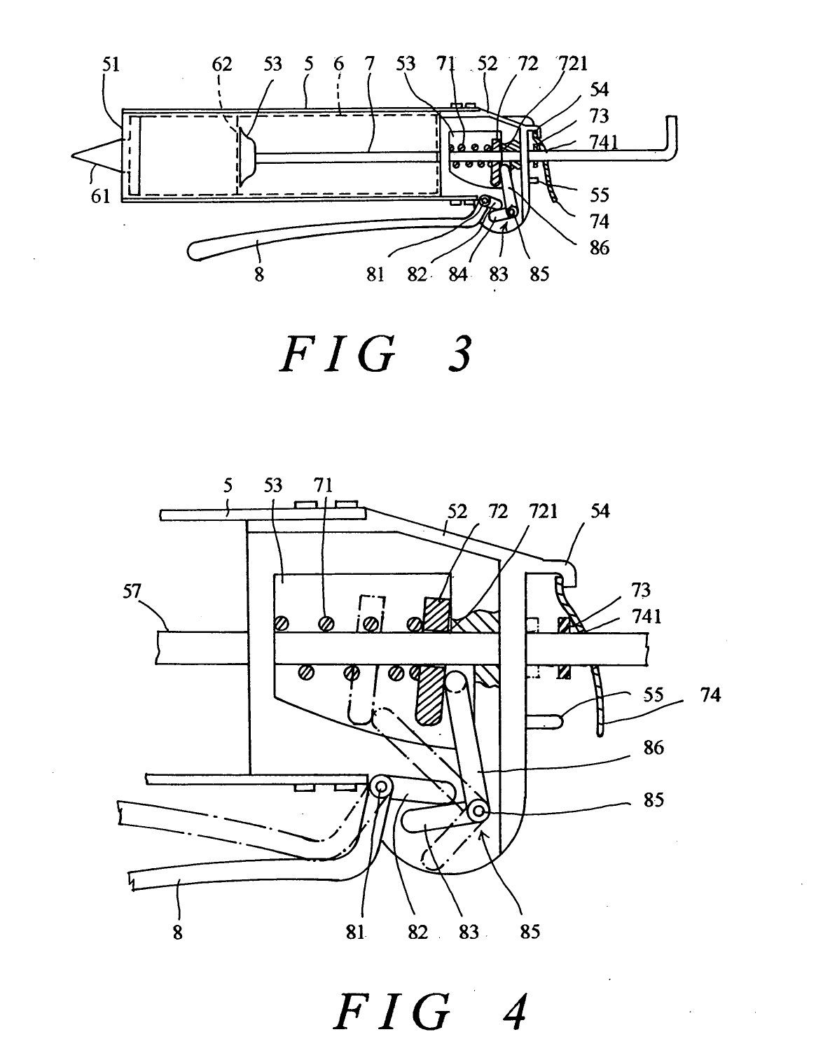

Referring to FIG. 3, the extruding implement of a preferred embodiment of the present invention comprises: a base 5; a front blocking base 51 disposed at the front end; a rear base 52 disposed at the rear end; a silicon gel can 6 accommodated between the front block base 51 and the rear base 52, such that a conical nozzle 61 of the silicon gel can 6 protrudes to the front of the front blocking base 51; a push rod 7 passing through the rear base 52, and one end of the push rod 7 extending into the base 5 and its front end having a pressing disc 53 to press a movable rear cover 62 in the silicon gel can 6; the push rod 7 in a hollow hole 53 of the rear base 52 being pivotally coupled to a first elastic member 71 and a first latch plate 72; the push rod 7 outside the rear base 52 has a latch member 73 between the rear base 52 and the second latch plate 74, and the latch member 73 having an appropriate latching force to latch the push rod 7, and requiring an appropriate external force to be pushed, and the width of said latch member 73 being smaller than the distance between the rear base 52 and the second latch plate 74. The material of the latch member 7 could be flexible rubber or plastic or non-flexible metals; and could be an object in the shape of an O-shaped ring or a C-shaped ring, or could be an elastic spring with only a few joints; one end of the second latch plate 74 is blocked by a latch base 54 of the rear base 52, and a blocking member 55 is disposed on the rear base 52; a handle 8 being pivotally coupled to the rear base 52 and disposed on one side of the base 5 substantially parallel to the base 5 and the push rod 7 or in an aslant position as shown in FIG. 3; a first resisting arm 82 on another end of the pivotal point 81 of the handle 8 can push and press against the first exerting aim 84 of the pushing member 83 at the rear base 52, and the second resisting arm 86 on the other end of the pivotal point 85 of the pushing member 83 can press the first latch plate 72 in the hollow hole 53. If a user wants to perform the gel injection, the user holds the handle 8 and pushes it towards the base 5 as shown in FIG. 4, and then the first resisting arm 82 will press the first exerting arm 84, and the second resisting arm 86 can tilt the first latch plate 72 and uses the axial hole 721 to latch and push the push rod 7 forward. At that time, the latch member 5 will also be driven towards the rear base 52. When the handle 8 is released, only the first latch plate will be moved backward by the restoration of the first elastic member 71 and drive the push rod 7 backward. The latch member 73 will also be driven to move backward until it is in contact with the second latch plate 74, such that the axial hole 741 will be aslant and latch the push rod 7, which makes the push rod 7 unable to move backward. At that time, the handle 8 continues relaxing, so that the aslant situation of the first latch plate 72 will be released, and no longer latches the push rod 7, and moves backward to the position as shown in the imaginary line of FIG. 4 after the push rod 7 is acted by the first elastic member 71. Such design allows a large advancement and a slight backward displacement.

If we want to shift the push rod 7 backward, we need to press the second latch plate 74 against the blocking body 55, so that the axial hole 741 of the second latch plate 73 will release the aslant latch rod 3 and allow the push rod to be pulled out.

Since the handle 8, the base 5, and the push rod 7 according to the embodiments of the present invention are substantially disposed in the radial direction in order to save the volume of packing material and eliminate the burden to the support and application of the handle 8 by the moment of force of the weight. Using hands to directly hold the silicon gel can of the base 5 makes the operation by one hand much stabler and easier. Even when the user is using it at a high place, there is no safety concern. Since the handle can be extended to the entire length of the base 5 and the length of exerting arm is several times as long as the resisting arm, therefore it gives a lever to make the operation easier and labor-saving. The operator can easily perform the construction and keep the quality to the expected conditions. When the handle 8 according to the embodiment of the present invention is released, the push rod 7 will not stand still, but continue to move for a small distance before it stops. It makes the elastic semi-solidified silicon gel liquid in the silicon gel can 6 to have the restoring elasticity when the push rod 7 moves backward in a sudden and produces a gap between the rear cover 62 of the silicon gel can and the front end of the push rod 7 while the gel is squeezed by the inertia, so that the rear cover 62 having a backward restoration displaces slightly, and forms an appropriate pressure onto the silicon gel can 6 to avoid the continual squeezing. Therefore, such arrangement provides a better control on the squeezing of the silicon gel and a better construction quality.

While the present invention has been described in connection with what is considered the most practical and preferred embodiment, it is understood that the invention is not limited to the disclosed embodiments but is intended to cover various arrangements included within the spirit and scope of the broadest interpretation and equivalent arrangements.

1. An extruding implement structure, comprising a base; a front blocking base disposed at the front end; a rear base disposed at the rear end; a silicon gel can accommodated in the base between the front blocking base and the rear base; a push rod passing through the rear base, and one end of the push rod extending deep into the base and pressing a movable rear cover in the silicon gel can; the push rod inside the rear base being pivotally coupled to a first elastic member and a first latch plate; the push rod outside the rear base is pivotally coupled to a second elastic member and a second latch plate; a handle being operated to drive the first latch plate to push the push rod forward; characterized in that said handle being pivotally coupled to the rear base and disposed on one side of the base substantially parallel to the base and the push rod or in an aslant position; if a user wanting to push the push rod forward to press the pressing disc deep into the silicon gel can and push the rear cover for the gel injection, the user just holding the handle and pushing the handle towards the base.

2. The extruding implement structure as claimed in claim 1, wherein said handle uses a first resisting arm on one side of the pivotal point to push and press a pushing member of a first exerting arm at the rear base, and the pushing member uses a second resisting arm on another side of the pivotal point to press said first latch plate.

3. An extruding implement structure, comprising a base; a front blocking base disposed at the front end; a rear base disposed at the rear end; a silicon gel can accommodated in the base between the front blocking base and the rear base; a push rod passing through the rear base, and one end of the push rod extending deep into the base and pressing a movable rear cover in the silicon gel can; the push rod inside the rear base being pivotally coupled to a first elastic member and a first latch plate; the push rod outside the rear base is pivotally coupled to a second elastic member and a second latch plate; a handle being operated to drive the first latch plate to push the push rod forward; characterized in that a latch member being latched between the outside of the rear base and the second latch plate, and said latch member having an appropriate latching force to latch the push rod, and requiring an appropriate external force to be pushed, and the width of said latch member being smaller than the distance between the rear base and the second latch plate.

4. The extruding implement structure as claimed in claim 3, wherein said latch member is made of a flexible material.

5. The extruding implement structure as claimed in claim 3, wherein said latch member is made of a non-flexible material.

6. The extruding implement structure as claimed in claim 3, wherein said latch member is an O-shape ring member.

7. The extruding implement structure as claimed in claim 3, wherein said latch member is a C-shape ring member.

8. The extruding implement structure as claimed in claim 3, wherein said latch member is a spring with only a small number of joints.

9. The extruding implement structure as claimed in claim 3, wherein said latch member is latched between the outside of the rear base and the second latch plate, having an appropriate latching force to latch the push rod, and requiring an appropriate external force to be pushed, and the width of said latch member being smaller than the distance between the rear base and the second latch plate.
